(19) United States
(12) Patent Application Publication
(10) Pub. No.: US 2021/0235638 A1
(43) Pub. Date: Aug. 5, 2021

(54) WEATHER MANAGEMENT OF CYCLONIC EVENTS

(71) Applicant: Lawrence Sirovich, NEW YORK, NY (US)

(72) Inventor: Lawrence Sirovich, NEW YORK, NY (US)

(21) Appl. No.: 17/150,931

(22) Filed: Jan. 15, 2021

Related U.S. Application Data
(63) Continuation-in-part of application No. 16/778,679, filed on Jan. 31, 2020, now abandoned.

(51) Int. Cl. A01G 15/00

(52) U.S. Cl. CPC A01G 15/00

(57) ABSTRACT

A method of mitigating the formation of a hurricane comprising the steps of, upon detection of a tropical depression resulting in predetermined cyclonic activity quickly dispatching, to the center of a disturbance, a plurality of vessels modified for generating turbulence mixing of ocean water. The vessels undertake an anti-cyclonic outward spiral track at the center of the disturbance that is opposite to said predetermined cyclonic activity to negate ambient circulation and directly interfere with hurricane production, and continuing said anti-cyclonic outward spiral while following said center of said disturbance until the threat of a hurricane is eliminated. A similar method may be used to promote the formation of a hurricane causing said plurality of vessels to undertake a cyclonic outward spiral track at the center of the disturbance that is in the same direction to a predetermined cyclonic activity to enhance ambient circulation and directly promote hurricane production.

### CROSS-REFERENCE TO RELATED APPLICATION

This application is related to U.S. patent application Ser. No. 13/610,345 filed on Sep. 11, 2012 issued as U.S. Pat. No. 9,078,402 on Jul. 14, 2015, that was a continuation-in-part (CIP) of U.S. patent application Ser. No. 11/317,062 filed on Dec. 22, 2005 issued as U.S. Pat. No. 8,262,314 on Sep. 11, 2012; and is a continuation-in-part (CIP) of pending U.S. patent application Ser. No. 16/778,679 filed on Jan. 31, 2020, all of which are incorporated as if fully set forth herein.

### BACKGROUND OF THE INVENTION

### 1. Field of the Invention

The present invention generally relates to the field of weather modification and, more specifically, to weather management of cyclonic events.

### 2. Description of the Prior Art

The images of devastation to the Bahamas by hurricane Dorian reveal, in compelling fashion, the economic and human costs of hurricanes. It has been estimated that, in future, economic costs will rise to between $10 billion and $10 trillion dollars per year. Hurricane Katrina, the most costly of US hurricanes, had an estimated cost of $160 billion and claimed 1600 deaths. The deadliest cyclonic even ever was the 1970 Behola cyclone reported to have taken 500,000 lives.

Presently, the best advice for escaping the devastation of hurricanes is to build stronger structures, or to have people hasten to higher ground. It is the intent of this report to shed light on feasible, technologically based solutions to this global problem, which are practical. It is the contention of this report that the question is not whether the proposed framework is workable, but rather what must be done to optimize its workability.

A hurricane, at a diameter of a thousand miles is huge, and packing the energy of 100,000 medium-sized atomic bombs (Monin, 1972) [1] (1019 Joules), it is a monster. To attempt controlling such a monster might seem a fool's quest. Yet, it is an established fact that a typical hurricane, 10 hours after making landfall, has its intensity reduced by more than a factor of 1/2, as demonstrated by (Kaplan & DeMaria, 2001) [2],

Vₘ(t)=V⁰ₘe^{-t/τ};τ≈10 hr, (1)

where Vₘ (t) is the maximal wind velocity of hurricane at time t, V⁰ₘ in its value at landfall and τ is the time constant. This, as will be seen, leads to profound implications.

Two reports “Managing the Risks of Extreme Events and Disasters to Advance Climate Change Adaptation”, Special Report of the Intergovernmental Panel on Climate Change, 2012) [3] henceforth referred to as Managing (see NYTimes, July 10 editorial, “Heating Up) [4] and “The Impact of Climate Change on the Hurricane Damages in the United States” (R. Mendelsohn, K. Emanuel, S. Chonabayashi, The World Bank, Finance Economics and Urban Department, Global Facility for Disaster Reduction and Recovery, 2011) [5] henceforth referred to as Impact portend possible dire consequences of climate change. While the quality and quantity of climate change may be debatable the risks that this change foreshadows cannot be ignored. Both reports show the need for a unified long term program to explore possibilities for diminishing the devastating consequences of tropical cyclone activity. It is the recommendation in this application and applicant's parent application, now issued as U.S. Pat. No. 8,262,314 (“Patent”) [6], that the techniques proposed by applicant provide viable solutions to the prevention of devastating storms and hurricanes.

Impact is a wide ranging comprehensive report based on known statistics and extensive modeling of hurricane activity in the United States. Both Impact & Managing point out that for example a Katrina is an example of a rare event, as are many extreme natural disasters, and therefore one cannot draw convincing predictions from a history of such events. But if climate change is indeed occurring, then increased incidence of such rare events is a compelling consequence.

Intense cyclonic events are global phenomena and in the United States account on average for about $10 billion/year cost in damages (Impact, 2011). In the absence of climate change, and purely on the basis of income and population growth by the year 2100 the forecast is this will rise to between $27 billion/year and $55 billion/year (Impact, 2011).

If climate change predictions are incorporated the yearly destructive costs are expected to lie between $70 billion and $120 billion by the year 2100. Additional effects such as sea level rise have not been factored into these calculations (Impact, 2011).

The world's oceans and seas, as for example in the Northern hemisphere, typically have temperature versus depth profiles that can be characterized generally as shown in FIG. 1. For example, the upper layer is usually at a uniform temperature. The temperature is determined by the intensity and duration of solar radiation, as well as the efficiency of wind driven surface driven mixing. Although the depth of the upper layer varies depending on the season, a nominal depth for the upper layer is approximately 20-25 meters. Deeper water is colder than the upper layer. The transition region between upper and lower layers is referred to as the thermocline. The thermocline has a nominal thickness of approximately 20 meters. Although these dimensions vary with time of year and geographic location, the numbers presented are illustrative.

It is well-known that North America hurricanes originate in tropical storms spawned in the tropical waters off the west coast of Africa. It also is understood that the originating tropical storms, and the hurricanes that develop from them, are fueled by the energy content of the warm, upper layers of the ocean. There is correlation between the frequency and strength of such storms and the energy of those upper, heated layers of the ocean.

Accordingly, decreasing the temperature of this upper layer of ocean water diminishes the occurrence and intensity of tropical storms.

U.S. Pat. Nos. 4,470,544 and 5,492,274 disclose methods for mixing of sea water to achieve greater rainfall in the Mediterranean basin. Mixing layers of a large body of water increases the potential of solar energy being captured by the water, and increases the intensity of storms fueled by the energy content of the seawater. The goal of both these patents is to thicken the upper ˜20 m warm surface layer over the course of months, by the use of surface vessels and devices.

By contrast, U.S. Pat. Nos. 9,078,402 and 8,262,314 are directed at mixing the thermocline with the surface layer, a region ˜100 m, quickly, less than one day, by submerged devices, which faced no danger by eminent hurricanes and without creating navigational obstructions. The submerged devices, namely submarines, used vertical plates or other bluff surfaces upstream of the stern creating eddy currents and turbulence surrounding the hull, interfering with the normal propulsion of the submarines.

### SUMMARY OF THE INVENTION

The present invention is for a method of mitigating the formation of a hurricane comprising the steps of

(a) upon detection or the forecast of a tropical depression resulting in predetermined cyclonic activity quickly dispatching, to the center of a disturbance, a plurality of vessels modified for generating turbulence mixing of ocean water;

(b) causing said plurality of vessels to undertake an anti-cyclonic outward spiral track at the center of the disturbance that is opposite to said predetermined cyclonic activity to negate ambient circulation and directly interfere with hurricane production; and

(c) continuing said anti-cyclonic outward spiral while following said center of said disturbance until the threat of a hurricane is eliminated.

The invention is also for a method of promoting the formation of a hurricane comprising the steps of

(a) upon detection or the forecast of a tropical depression resulting in predetermined cyclonic activity quickly dispatching, to the center of a disturbance, a plurality of vessels modified for generating turbulence mixing of ocean water;

(b) causing said plurality of vessels to undertake a cyclonic outward spiral track at the center of the disturbance that is in the same direction to said predetermined cyclonic activity to enhance ambient circulation and directly promote hurricane production; and

(c) continuing said cyclonic outward spiral while following said center of said disturbance until the initiation of the formation of a hurricane is established.

### BRIEF DESCRIPTION OF THE DRAWINGS

The above and other aspects, features and advantages of the present invention will be more apparent from the following description when taken in conjunction with the accompanying drawings, in which:

FIG. 1 is a diagram depicting the water depth of the thermocline for various months of the year in an area of the North Atlantic;

FIG. 2 is a diagram depicting a nominal cross-section of the warmer, upper layer of a large body of water and the cooler, lower layer of the large body of water;

FIG. 3 illustrates examples of ocean temperature variations for the month of August in the Gulf of Mexico, the Caribbean and the Atlantic Ocean;

FIG. 4 illustrates, as an example, the path or course of the 1988 Hurricane Gilbert as it passed over the Yucatan Peninsula into the Gulf of Mexico before reaching the Mexico mainland;

FIG. 5 illustrates an image of the sea temperature on Sep. 12, 1988 prior to Hurricane Gilbert traversing the trajectory shown in FIG. 4;

FIG. 6 is similar to FIG. 5 but illustrates the sea temperature on Sep. 17, 1998 after Hurricane Gilbert has traversed the trajectory shown in FIG. 4 and made landfall;

FIG. 7 illustrates streamlines for the inviscid model of a tropical depression on the ocean, based on a circular region around the origin, corresponding to a radius of 75 miles;

FIG. 8 illustrates an exemplary path of a submarine in the region of a tropical storm before it develops into a hurricane;

FIG. 9 illustrates a plurality of submarines moving along paths suggested in FIG. 8 to prevent a tropical storm from developing into a hurricane; and

FIG. 10 illustrates an exemplary path for a submarine for reducing the temperature while moving the water in a clockwise cyclonic direction to counter the natural counterclockwise vorticity induced in the Northern Hemisphere by the Earth's rotation.

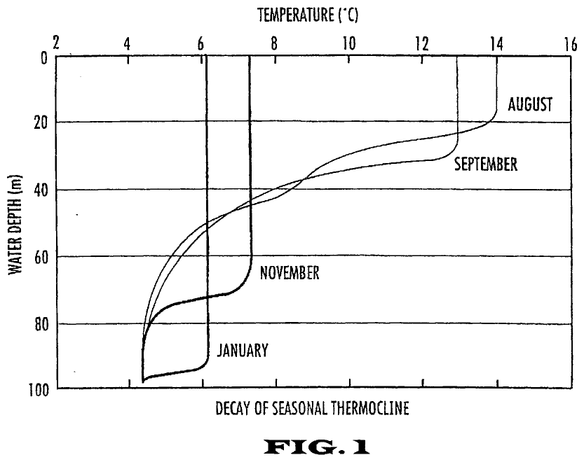

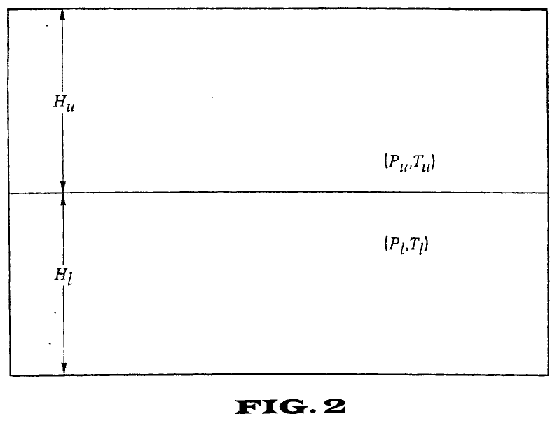

### DETAILED DESCRIPTION

Gray (1979) [7], summarizes conditions deemed necessary, thermodynamic and mechanical, in order to generate and sustain a hurricane. The key condition is that the ocean surface layer must be at least 26° C., in order to provide sufficient latent-heat input to sustain cyclonic activity. Gallacher et al (1989) [8], and Emanuel (1989) [9], indicate that “a 2.5° C. decrease in temperature near the core of the storm (hurricane) would suffice to shut down energy production entirely”. At ocean depths below the surface layer (˜20 m) the thermocline begins and leads to a near limitless supply of very cold ocean water. Nominally, the deep cold ocean water is only 0.2% denser than the warm surface layer of ocean. Thus, relatively little work is required to lift the cold water to the surface. A central idea discussed in Applicant's U.S. Pat. No. 8,262,314 is that deep cold ocean water can be used to cool the surface layer along the hurricane path in order to diminish the intensity of an evolving hurricane.

Simply lifting cold ocean water to the surface is inadequate for cooling the surface layer since the prevailing stratification will restore the colder ocean water to its appropriate depth, with negligible mixing. Thorough mixing of the warm surface layer with the deep cool ocean water will be required to produce a new cooler and relatively stable surface layer. Turbulent mixing provides the optimal method for achieving the mixing of the warmer surface and cooler thermocline layers.

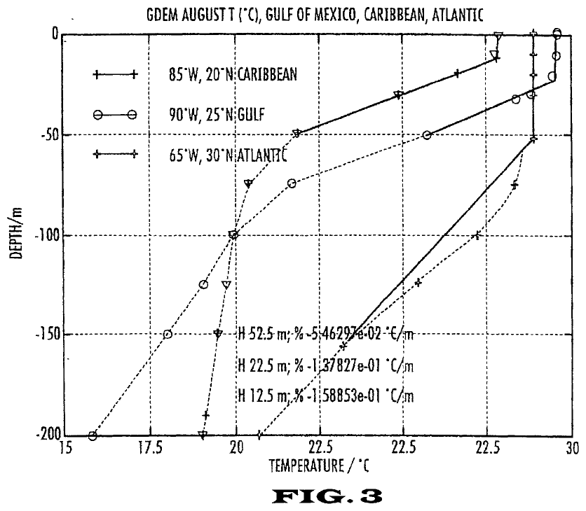

FIG. 3 shows three examples of ocean temperature variations in the Atlantic profile (east of Georgia/Florida). As a model calculation, it should be sufficient to cool the path of the hurricane track by 5° C. the above-mentioned 10 hours before landfall in order to diminish the intensity of a hurricane. Based on a 30 mile wide core hurricane track and a 12 mph speed of the hurricane this requires 12 mi.×10 mi.×30 mi.=3600 sq miles 1010 m2 will need to be cooled. Thus multiplying (7) by 1010 yields

W≈10¹⁴ Joules (1)

of work which is roughly the yield of one (Nagasaki) atomic bomb.

The dynamical description of hurricanes, (cyclones), is complex, which if done properly involves the thermodynamics of wet air, dissipative effects, and a three-dimensional geometry that extends from the ocean surface to the troposphere. The initiation of a cyclone, depends only on suitable ocean conditions, which can be described in relatively simply terms.

There are two essential elements for cyclone initiation: (1) sufficient ocean circulation, originating in the Earth's rotation, and; (2) adequate fueling by a warm ocean surface layer. In regard to the first of these it should be observed that the earth rotates in counterclockwise manner in the northern hemisphere (clockwise in the southern hemisphere), with rotation rate Ω=360° (=2π a radians) per 24 hours, in customary units given by, There are two essential elements for cyclone initiation: (1) sufficient ocean circulation, originating in the Earth's rotation, and; (2) adequate fueling by a warm ocean surface layer. In regard to the first of these it should be observed that the earth rotates in counterclockwise manner in the northern hemisphere (clockwise in the southern hemisphere), with rotation rate Ω=360° (=2π radians) per 24 hours, in customary units given by,

Ω=7.3×10⁻⁵rad·s⁻¹ (2)

a seemingly small, but indispensable effect. True local rotation depends on latitude, φ, as given by

Ωₒ=Ω sin φ,−90 °<<90° (3)

e.g., at the equator φ=0, hence there is almost no circulation in the neighborhood of the equator, which explains why equatorial cyclones are rare.

### Example

Consider the example of North Atlantic hurricanes. In the neighborhood of southern latitudes φ<20°, there is only a small counterclockwise circulation (2) in the atmosphere. This, accompanied by warm ocean layer, can ignite a series of events causing a warm ocean spray emitted from the ocean, that carries latent heat that allows moist air to rise, within the eye of the hurricane, to the troposphere. The accompanying atmospheric dynamics creates a positive feedback that concentrates the circulation in the eye of the cyclone so that local wind speeds can exceed 200 ft/sec. Similarly, the upper layer ocean also undergoes an intensifying counterclockwise motion, which from the Coriolis effect produces a radially inward motion of the warm sea water; which in turn induces a large-scale eddy, below the surface. Ocean dynamics will next be considered in more detail, with the intention of demonstrating how such events may be mitigated.

The dynamics of the upper ocean layer may be modeled by a planar, two-dimensional inviscid rotationally symmetric system of equations, in which the vertical axis is collapsed and dissipative mechanisms neglected, a big picture view.

$$C \text{:} \frac{\partial r {u}_{r}}{\partial r} + \frac{\partial {u}_{θ}}{\partial θ} = 0 \\ {M}_{r} \text{:} \frac{\partial {u}_{r}}{\partial t} + {u}_{r} \frac{\partial {u}_{r}}{\partial r} - \frac{{u}_{θ}^{2}}{r} + \frac{1}{ρ} \frac{\partial p}{\partial r} = 2 {Ω}_{o}^{2} r - 2 {Ω}_{o} {u}_{θ} \\ {M}_{θ} \text{:} \frac{\partial {η}_{θ}}{\partial t} + {u}_{r} \frac{\partial {u}_{θ}}{\partial r} + \frac{{u}_{r} {u}_{θ}}{r} = 2 {Ω}_{o} {u}_{r} , \qquad ( 4 )$$

Consider the steady solution of (4), as given by,

$${u}_{θ} = {Ω}_{o} r , \\ {u}_{r} = - k / r , \\ \frac{1}{ρ} \frac{\partial p}{\partial r} = - \frac{\partial }{\partial r} ( \frac{{u}_{r}^{2}}{2} ) + \frac{{u}_{θ}^{2}}{r} . \qquad ( 5 )$$

In (5), u_{θ} indicates the local latitudinal uniform rotation or circulation, which from the Coriolis effect produce an inward flow, uᵣ. Inward flow ceases when the pressure gradient ∂p/∂r, vanishes. The structure of (5) suggests that it is models a tropical disturbance, the precursor of hurricanes. To pursue this, we can choose k so the radius of the tropical storm is a typical 75 miles, and the latitude φ≈20°. It also follows that the streamline pattern of the putative model tropical disturbance is described by,

$$ψ = θ + \frac{{Ω}_{o} {r}^{2}}{2 k} . \qquad ( 6 )$$

An illustration of the stream function, (6) is shown in the FIG. 7 that shows streamlines for the inviscid model of a tropical depression on the ocean, based on a circular region around the origin, corresponding to a radius of 75 miles as described by (6). The streamlines correspond to ν=0°, darker lines, to θ=360°, lighter lines; a counterclockwise swirl of inflow. FIG. 7 is an idealized version of a tropical depression at a typical North Atlantic latitude. At more southerly latitudes, the streamlines tend to be radial, while more northerly latitudes the streamlines are more aswirl.

FIG. 7 suggests mechanisms for mitigating cyclonic behavior. In simplest terms, to inhibit the cyclonic formation, force anti-cyclonic motion upon the ocean surface layer, which induces negative circulation, and from Coriolis forces is accompanied by drawing cold ocean water to the surface; alternately, to promote cyclonic formation, force positive cyclonic action on the surface layer to cause hurricane ignition under otherwise benign conditions, which also pulls in warm surface ocean.

A 1^{st} Strategy

Using landfall as an example, one can imagine the possibility of creating an artificial landfall on the hurricane track, by cooling a deep enough stratum of the track, to a temperature below 26° C., the established critical temperature for cyclonic creation and maintenance. To put this possibility into concrete terms, consider a nominal North Atlantic hurricane of eye diameter 30 miles, traveling at 12 mph, over a surface layer at 27° C., and depth of 20 m, on the track of the hurricane. Typically, such a layer rests on a thermocline of linearly declining temperature that descends to 20° C. for the next 50 m in depth. Calculations demonstrate that this 120 mile×30 mile×70 m stratum can be mixed, in a timely manner, to a uniform temperature of 22° C. When this stratum is properly placed, the hurricane will arrive at the true landfall with well less than one half the original intensity. The calculated energy cost of creating this artificial landfall is 10¹⁴ Joules. Further calculation shows that the task can be accomplished by 10 nuclear submarines. Temperature is virtually a passive scalar, and relatively little work is required in mixing. As an aside, it is worth iterating that the mixing has been accomplished as a result of an immense coefficient of performance ˜10⁴, derived from the fact that the cold deep ocean is 0.2% heavier than the surface layer, see below.

A key element is the recognition that, unlike a military submarine, there is no need for the submarines wake to be undetectable. This leads to a significant reduction in performance overhead and the possibility of adopting a radical change in propeller architecture. It is contemplated that the nuclear submarines should be modified to have variable propeller diameter, to allow a diameter of ˜35-40 m, when mixing takes place. If we consider the example of an Ohio class submarine, the Reynolds number is Re˜10⁸ and the and nothing at all resulting flows are fully turbulent. Under the action of turbulent diffusion and rotation of the propellers, a fully mixed, expanding wake will result. Based on well-established empirical models, one can confidently predict that the turbulent wake will have a diameter of 100 m, our intended goal, after one submarine length of travel.

A 2^{nd} Strategy

North Atlantic tropical depressions and storms are spawned off the west coast of Africa. Most North Atlantic hurricanes have their origins in these events, and these occurrences are monitored by NOAA, as is their potential threat. On this basis, we might consider an alternate strategy, whereby submarines are quickly dispatched to a disturbance location deemed likely to develop into a hurricane. For example, Dorian was recognized as a threat on Aug. 23, 2019; within one week it exhibited cyclonic behavior. It is proposed that submarines be dispatched at such a time and location, with the mission of cooling the danger patch, and pursuing the zone of the tropical disturbance until it no longer poses a threat. This alternate strategy has several advantages: the need for precise track forecasting is diminished; also, it is likely that fewer submarines are required; and since the potential storm has little opportunity to store moisture, the usual, often devastating, heavy rainfall associated with hurricanes is eliminated. When possible, the 2^{nd} strategy is the superior strategy.

Since the ocean surface can be modeled as a reflecting boundary which implies that wake diameter might be doubled; and in view of the density gradient the lateral spread of the wake is significantly enhanced, especially under the phenomenon of wake collapse (Schooley, 1967). From this it can be observed from FIG. 10 that the sea surface is tessellated into squares so that spread need only reach to approximately 6.67 miles or 10.62 km can achieve full mixing.

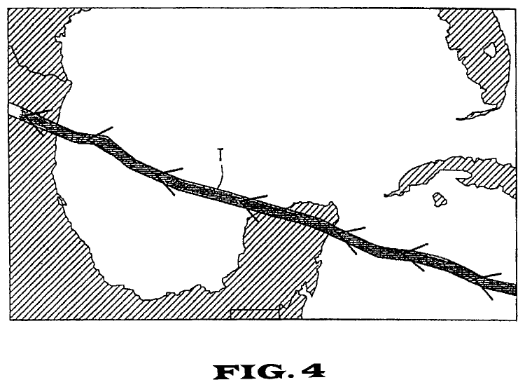

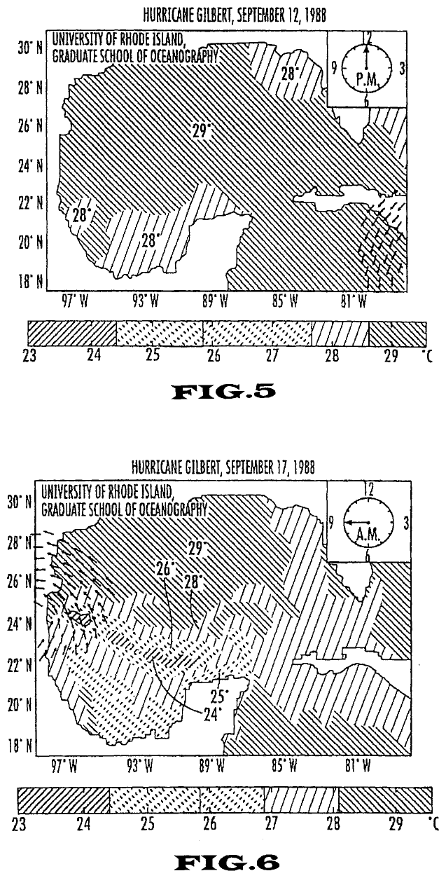

A concern might be whether cooling would persist long enough to be effective. Support for the efficacy of the above mixing approach to ocean cooling comes from sea surface imagery of hurricanes. A consequence of a hurricane passing over an ocean is that it performs the same type of ocean mixing that is proposed to achieve. FIG. 4 illustrates the path or course of the 1998 Hurricane Gilbert, moving from East to West from the Caribbean over the Yucatan Peninsula into the Gulf of Mexico before the landfall over Mexico. In FIGS. 12-13 sea surface temperature images are shown acquired for the 1988 hurricane Gilbert as it passed over the Yucatan into the Gulf of Mexico (a full AVI file is obtainable from the University of Rhode Island). FIG. 5 shows sea surface temperatures roughly a day before the track passes over the Yucatan. Thus, on Sep. 12, 1998 the body of water to be traversed by Hurricane Gilbert was approximately 29° C. and some coastal regions approximately 28° C. Sea surface temperatures four days later are shown in FIG. 5, where temperatures along the track of the eye of the hurricane dropped 4-5° C. to 24-25° C. and the water adjoining the track dropped approximately 3° C. to 26° C. The considerable lateral spread and the persistence of cooling is clear from the imagery. Concern about the temporal persistence of ocean cooling is certainly dispelled. Clearly four days after the passing of the hurricane, the sea surface layer remains well cooled.

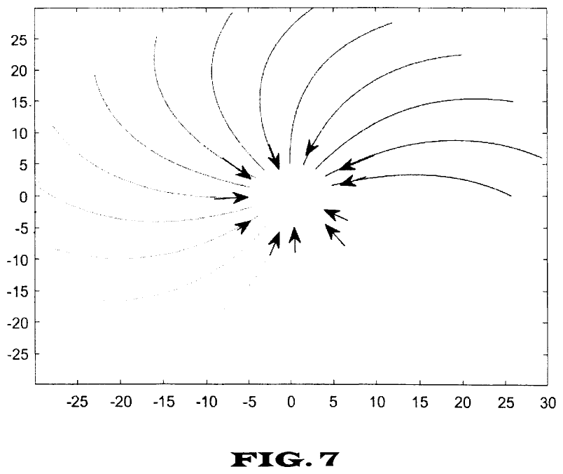

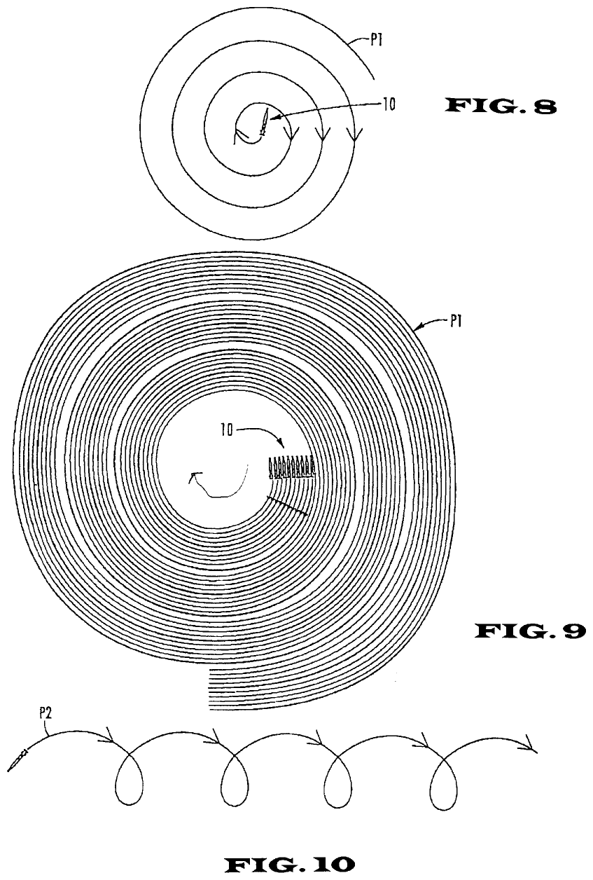

In regard to the 2^{nd} strategy, referring to FIG. 8 an exemplary path P1 of a single submarine 10 is shown that can be traversed in the region of a tropical storm before it develops into a hurricane. For hurricanes developing in the Northern Hemisphere, cyclonic wind flow is in a counterclockwise direction, a submarine is shown to travel along a spiral path in a clockwise direction. When provided with components that enhance or optimize the creation of turbulent flow at high Reynolds numbers to produce chaotic eddies, vortices and other flow instabilities, such movement of the submarine both mixes the warmer and colder layers of water and counteracts the natural counterclockwise embryonic cyclonic wind flows and sea's cyclonic vorticity due to the Earth's rotation to neutralize or reduce their effectiveness to intensify and even develop an eye. In FIG. 9, ten submarines move in parallel anti-cyclonic spiral paths P1 to enhance both mixing of the water to lower the surface temperature and counteract the normally counterclockwise spiraling of both water and air movements, in the Northern Hemisphere, while the conditions are still those of a tropical depression (sustained winds of up to 29 knots) or a tropical storm (sustained winds of up to 30-55 knots).

While the patterns shown in FIGS. 8 and 9 might be implemented when a tropical depression or storm is substantially stationary, large scale winds in the Earth's atmosphere and other factors, such as other low pressure systems, high pressure systems and warm and cold fronts, cause essentially linear movements along a path or track T (FIG. 4), as suggested in FIG. 5. To address such movements along a linear track one or more submarines can move along a cycloid-like path P2 in a horizontal plane, as suggested in FIG. 10, wherein the submarines move both in a clockwise direction while following a linear path coextensive with the track of the tropical storm. Such movement of submarines with turbulence generating devices spins the water in a clockwise motion to introduce a negative vortex to counter the natural tendency to spin in a counterclockwise direction due to the rotation of the Earth.

The foregoing presents compelling evidence that the following three steps should be taken:
Large scale simulation of the effect of the suggested ocean cooling on the intensity of hurricanes.
Large scale simulation of the suggested ocean cooling of tropical storms.
Fit and test a real submarine with a turbulating device by monitoring its performance in achieving ocean cooling through satellite imagery.

Alteration of Hurricane Paths and Intensity.

Current modeling and simulation provide reasonable forecasts for hurricane paths for up to 5 days. The core region of a hurricane, which accounts for energy uptake of the upper warmer layer of ocean, generally spans an area approximately 50 km×50 km. Such a region can be cooled 5° C. by 9 submarines in approximately 18 hours.

The above determined 18 kts modified submarine speed permits the submarines to outrun the hurricane. An interactive strategy of ocean cooling and renewed path forecasting provides a dynamic program for quenching and/or redirecting hurricanes. Under natural conditions, the path of a hurricane is determined by available warm surface waters to fuel its movement and intensity. Therefore, selective cooling of the upper layer of ocean water can be used to redirect the path to areas less vulnerable than populated cities, such as the open ocean. However, to be effective the cooling must be timely and include mixing ahead or in advance of a hurricane but not too long in advance. Effective mixing and cooling should be implemented 1-2 days before a hurricane traverses its course to allow the body of water to stabilize at its reduced temperature without allowing the surface layer to revert to its higher temperature.

The possibility also exists for cooling the upper layers of the ocean surrounding the core region of a hurricane, thereby stalling the hurricane at sea. By continuing to encircle the hurricane, the intensity of the hurricane may be reduced.

It has been suggested that ocean mixing might raise concerns from environmentalists. This should not become an issue since it is well documented that mixing of the sort proposed here can only enhance the food chain in oceans, and in addition will mix the well oxygenated surface layer of oceans, the lack of which is an ongoing concern in the environmental community.

The proposed application to tropical storms and depressions requires a somewhat different strategy since tropical storms and depressions have a less well-defined structure than a hurricane. Under such circumstances it is proposed that the submarine pattern take on outward anti-cyclonic spiraling tracks, adjusted to travel with the center of the storm activity. The purpose of the anti-cyclonic element is to use the entrained fluid motion created by the submarine pack to confer a component of anti-cyclonic vorticity. One of the essential conditions, not specifically mentioned above, is the need of cyclonic vorticity in the ocean for hurricane production. This is normally induced by the earth's rotation. (Zero vorticity is induced at the equator, and virtually no hurricane activity occurs in a ±5° belt of the equator.)

Negating the natural vorticity therefore becomes an addition to diminishing the effect on hurricane formation. This concept shown in FIG. 7 can also be adapted to tracks depicted in FIG. 10.

By “quick” dispatch or deployment to the region of tropical depression is, for purposes of this application, three to four days when the depression is first detected or forecast. This should be adequate for most cases since NOAA forecasts such tropical depressions from satellite data approximately five days prior to formation of depressions and tropical storms. While almost any region can be reached in three to four days it is advantageous to maintain bases close to locations that are historically known where such depressions or storms originate, normally between 30-60 degree latitudes where mid-latitude cyclones typically originate. Some possible locations for such bases can include Bermuda, Cuba and locations near the West Coast of Africa.

### Mitigation Methods

The appearance of tropical disturbances is routinely monitored by NOAA, thus a mitigation strategy would be to diminish both ocean circulation and surface temperature, the two key elements that fuel cyclonic production by:
the quick dispatch, to the center of the disturbance, of a suitable pack of vessels, ideally submarines, the fastest ocean vessels, and modified for maximal turbulence mixing.
the pack should undertake an anti-cyclonic outward spiral track.
repetition of this track until the threat of a hurricane is eliminated
submarine stations, at well-positioned stations in or near the Caribbean would be a desirable element in such a plan.

Submarines, altered for ideal mixing (previous patents) reduce surface layer temperatures. The anti-cyclonic track of the submarine pack negates ambient circulation, and directly interferes with hurricane production. Also, the induced anti-cyclonic flow of the pack produce Coriolis forces that enhanced upwelling of cold ocean water.

The normal path of Atlantic storms is northward, and storms originating north of the 20th latitude rarely develop into hurricanes. Therefore, even delaying the initiation prove to be beneficial.

### Rainfall Management

The above deliberations can be reversed to enhance the initiation or promote the formation of a hurricane, as might be appropriate when the ecological need is rainfall production. Unlike the example of cloud seeding (a case of “robbing Peter to pay Paul”), such an enhancement provides a new sources of rain. Hurricanes are steered by ambient meteorological conditions, thus with such information in hand, and prior planning, favorable situations, might be opportunistically assayed, for time and place of hurricane occurrence. Thus the methods summary would be:
seek a rainfall opportunity, viz., a tropical depression which might be steered successfully
the quick dispatch, to the center of the disturbance, of a suitable pack of vessels, ideally submarines
the pack should undertake a cyclonic outward spiral track
repetition of this track until hurricane ignition is likely
submarine stations, at well-positioned stations would be a desirable option.

For Example: the state of California often needs rain, but rarely sees hurricanes. This might be altered by opportunistically looking for circumstances when a tropical disturbance can be enhanced, and then steered appropriately.

An opportunity for hurricane enhancement would be in New South Wales, Australia, which has a history of hurricanes, but is presently experiencing a devastating drought.

### Weather Management of Cyclonic Events

An ability to advance or retard hurricane formation can prove to be a valuable tool in weather management. The aim of this invention is to provide, in terms of examples and realistic estimates, frameworks for mitigating and preventing the economic and human devastation caused by cyclones. Water tunnel and numerical experiments can provide limited answers, since, Reynolds numbers are large, and temperature and density gradients place limits on experimental modeling. Modification of a single traditional submarine, along with a test program that includes satellite imagery might provide relatively low-cost answers to some questions. On the other hand, for the second strategy, quenching potential disturbances, a testing program might be started almost immediately.

Newly mixed cooled sea surface layer persists for days according to satellite imagery of an actual hurricane. Hurricane Gilbert (NOAA 1988), on Sep. 14, 1988 moved across the northwest coast of the Yucatan Peninsula, and as the imagery reveals, it churned the cold deep waters of the Gulf of Mexico, so that a wide swath of surface fell from 28° C. to 24° C. The satellite imagery demonstrated that five days later, as hurricane Gilbert passed over Mexico, the prior cooled sea surface layer still persisted. Further evidence that the cool ocean thoroughly mixes with the warm upper layer comes from (Knaff et al. 2013), who report that the mixed state can persist as long as 30 days.

Modifying a tropical depression has a decided advantage over earlier suggested hurricane modification methods. In particular this strategy leaves little opportunity for accumulating moisture, hence diminishing the usual heavy rainfall, and flooding that accompanies typical hurricanes.

Clearly the proposed undertaking will be expensive. However, the high cost of hurricanes, and the extremely high payoff, makes for an interesting expected gain calculation, which strongly suggests that this is a good bet. Along these lines, even if the intensity of a hurricane is reduced by only 20%, destructive costs are reduced by nearly 50%, which in dollars is immense.

Numerical and experimental investigations might lend further support to this proposal. But, in view of the high Reynolds number, stratified flow and very complicated geometries, convincing numerical and physical experiments are likely to prove problematical, and not helpful at this stage. It is the author's opinion that tweaking and additional resources will make the strategy work to any reasonable degree.

There are many future directions that will have to be pursued, such as the optimal covering of an ocean region, the cyclogenesis of disturbances and likely some stage experiments will be required. However, at this stage, such studies are premature. Establishing the principle hypothesis of this proposal, namely that ocean mixing diminishes the intensity of a hurricane, or under the strategy 2, that it can actually be eliminated before formation are first priorities.

As has been suggested, the proposed undertaking might require involvement by governments. Barring that, perhaps a modest and convincing demonstration can be envisioned. This could be based on the use of a conventional submarine, perhaps one that has been mothballed, and refitted with a large diameter propeller system. On this basis one can contemplate tests assessing the effects of mixing, as monitored by satellite imaging. If, as part of the process, accessibility to Electric Boat engineers is possible, this and many other questions could be answered.

Although certain preferred exemplary embodiments of the present invention have been shown and described in detail, it should be understood that various changes and modifications may be made therein without departing from the scope of the appended claims.

The foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed is:

1. A method of mitigating the formation of a hurricane comprising the steps of
(a) upon detection or the forecast of a tropical depression resulting in predetermined cyclonic activity quickly dispatching, to the center of a disturbance, a plurality of vessels modified for generating turbulence mixing of ocean water;
(b) causing said plurality of vessels to undertake an anti-cyclonic outward spiral track at the center of the disturbance that is opposite to said predetermined cyclonic activity to negate ambient circulation and directly interfere with hurricane production; and
(c) continuing said anti-cyclonic outward spiral while following said center of said disturbance until the threat of a hurricane is eliminated.

2. A method as defined in claim 1, further comprising maintaining bases or stations for said plurality of vessels at locations within 3-4 days travel to high risk regions where low pressure systems or tropical storms or cyclones frequently form.

3. A method of promoting the formation of a hurricane comprising the steps of
(a) upon detection or the forecast of a tropical depression resulting in predetermined cyclonic activity quickly dispatching, to the center of a disturbance, a plurality of vessels modified for generating turbulence mixing of ocean water;
(b) causing said plurality of vessels to undertake a cyclonic outward spiral track at the center of the disturbance that is in the same direction to said predetermined cyclonic activity to enhance ambient circulation and directly promote hurricane production; and
(c) continuing said cyclonic outward spiral while following said center of said disturbance until the initiation of the formation of a hurricane is established.

4. A method of promoting the formation of a hurricane comprising the steps of
(a) seeking a rainfall opportunity, viz., a tropical depression which might be steered successfully;
(b) quicky dispatching, to the center of a disturbance, plurality of vessels configured to generate turbulence for mixing of ocean water;
(c) causing said plurality of vessels to undertake a cyclonic outward spiral track that is in the same direction to enhance ambient circulation and directly promote hurricane production; and
(d) continuing the movements of said vessels until hurricane ignition is likely.
